(19) United States
(12) Patent Application Publication
(10) Pub. No.: US 2008/0262184 A1
(43) Pub. Date: Oct. 23, 2008

(54) POLYCARBAZOLYL(METH)ACRYLATE LIGHT EMISSIVE COMPOSITIONS

(75) Inventors: Qing Ye, Schenectady, NY (US); Jie Liu, Niskayuna, NY (US); Kyle Erik Litz, Ballston Spa, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/736,214

(22) Filed: Apr. 17, 2007

(51) Int. Cl. C08G 79/00

(52) U.S. Cl. 528/9

(57) ABSTRACT

The present invention provides polymer derived from a monomer of formula I

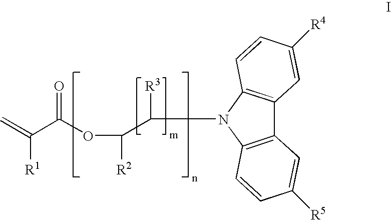

and a polymerizable phosphorescent organometallic compound of formula L′₂MZ′, wherein R¹ is H or CH₃; R² is H or C₁-C₅ alkyl; R³ is H or CH₃; R⁴ and R⁵ are independently H, CH₃, t-butyl, triarylsilyl, trialkylsilyl, diphenyl phosphine oxide, or diphenyl phosphine sulfide; m ranges from 1 to about 20; n ranges from 1 to about 20; L′ and Z′ are independently bidentate ligands; at least one of L′ and Z′ comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl; and M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Lr, Rf, Db, Sg, Bbh, Hs, Mt, Ds, Rg, Uub, Eu, Tb, La, Po, or a combination thereof. The polymers of the invention are useful as light emissive layers in light emitting devices. Thus. the present invention also provides an organic light emitting device comprising a light emissive layer comprising a polymer derived from a monomer of formula I, and a polymerizable phosphorescent organometallic compound of formula L′₂MZ′.

### CROSS-REFERENCE TO RELATED APPLICATIONS

This application is related to U.S. patent application entitled “Polycarbazolyl(Meth) Acrylate Light Missive Compositions,” filed concurrently herewith as attorney docket number 206738-1, the entire contents of which are incorporated herein by reference.

### BACKGROUND

Organic light emitting devices (OLEDs), which make use of thin film materials that emit light when subjected to a voltage bias, are expected to become an increasingly popular form of flat panel display technology. This is because OLEDs have a wide variety of potential applications, including cellphones, personal digital assistants (PDAs), computer displays, information displays in vehicles, television monitors, as well as light sources for general illumination. Due to their bright colors, wide viewing angle, compatibility with full motion video, broad temperature ranges, thin and conformable form factor, low power requirements and the potential for low cost manufacturing processes, OLEDs are seen as a future replacement technology for cathode ray tubes (CRTs) and liquid crystal displays (LCDs). Due to their high luminous efficiencies, OLEDs are seen as having the potential to replace incandescent, and perhaps even fluorescent, lamps for certain types of applications.

One approach to achieve full-color OLEDs includes energy transfer from host to emissive guest molecules. For this to be realized, the triplet energy state of the host has to be higher than the guest molecule. Carbazole derivatives have shown promise to perform well as host molecule in the presence of metal containing emissive guest molecules. Often used in this respect is poly(N-vinyl carbazole) (PVK). But PVK is not an ideal host candidate since its triplet energy gap is about 2.5 eV. Iridium (III) bis(4,6-difluorophenyl pyridinato-N,C²-picolinato) (FIrpic) is a blue phosphorescent dye which when used in OLEDs exhibits high quantum efficiency. The triplet energy gap for FIrpic is 2.7 eV which is greater than the triplet energy gap for PVK, resulting in reduced quantum efficiency in the devices. Thus, there is a need in the art to develop OLEDs having polymers with high triplet energy gaps, while still maintaining the potential for the molecules to host red, green, and blue emissive complexes.

### BRIEF DESCRIPTION

In one aspect, the invention provides a polymer derived from a monomer of formula I

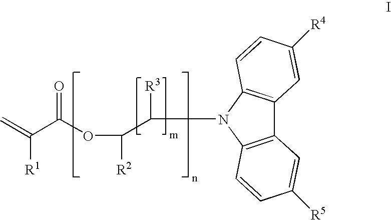

and a polymerizable phosphorescent organometallic compound of formula L′₂MZ′, wherein R¹ is H or CH₃; R² is H or C₁-C₅ alkyl; R³ is H or CH₃; R⁴ and R⁵ are independently H, CH₃, t-butyl, triarylsilyl, trialkylsilyl, diphenyl phosphine oxide, or diphenyl phosphine sulfide; m ranges from 1 to about 20; n ranges from 1 to about 20; L′ and Z′ are independently bidentate ligands; at least one of L′ and Z′ comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl; and M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Ga, Ge, In, Sn, Sb, Tl, Pb, Bi, Eu, Tb, La, Po, or a combination thereof.

In another aspect, the invention provides an organic light emitting device comprising at least one electrode, at least one charge injection layer, at least one light emissive layer comprising a polymer derived from a monomer of formula I, and a polymerizable phosphorescent organometallic compound of formula L′₂MZ′.

### DRAWINGS

These and other features, aspects, and advantages of the present invention will become better understood when the following detailed description is read with reference to the accompanying drawings in which like characters represent like parts throughout the drawings, wherein:

FIG. 1 shows a typical sky blue electrophosphorescent spectrum produced by an organic light emitting device comprising polymers of the invention.

FIG. 2 shows the efficiency as a function of bias voltage of an organic light emitting device comprising polymers of the invention. The squares represent the current efficiency measured in cd/A, while the triangles represent the power efficiency measured in lm/W.

### DETAILED DESCRIPTION

Polymers for use in the compositions and devices of the present invention include structural units derived from a monomer of formula I, which are methacrylate monomers having pendant carbazolyl groups. In some cases, the 3, 6 positions of the carbazole unit may be susceptible to oxidative coupling reactions, and it may be advantageous to protect one or more of these positions. Thus, in some embodiments, R⁴ and R⁵ are t-butyl groups, while in still other embodiments, R⁴ and R⁵ are trialkylsilyl and triarylsilyl groups, and in yet other embodiments, they are diphenyl phosphine oxide or diphenyl phosphine sulfide. A wide variety of other groups may also be used to protect the carbazole at the 3 and 6 positions, and these may include, but not limited to, methyl, ethyl, methoxy, tolyl, methylcyclohexyl, and halomethyl. In other embodiments, R⁴ and R⁵ are hydrogen, and the carbazole unit is unprotected at the 3 and 6 positions.

Monomers of formula I may be obtained in high yields by following synthetic procedures known in the art. Monomers of formula I are esters of (meth)acrylic acid and may be synthesized, for example, by the esterification reaction between (meth)acryloyl chloride and N-(2-hydroxyethyl)carbazole. The monomers are also commercially available from sources such as Aldrich Chemical Company, Milwaukee, Wis. Those skilled in the art will recognize that depending on the synthetic method utilized, the value of n and m may be an integer having a specific value, or may be a distribution and is represented as an average.

In one particular aspect, the values of n and m are 1, and the monomer has formula

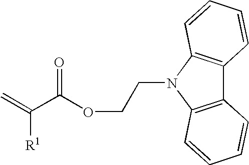

wherein R¹ is H or CH₃. In one particular embodiment, R¹ is CH₃, and the monomer is a methacrylate ester of formula

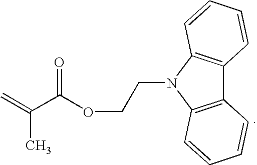

In another particular embodiment, R¹ is a H, and the monomer is an acrylate ester of formula

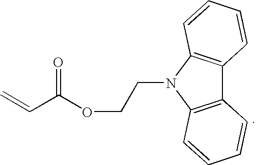

The monomers 2-(9-carbazolyl)-ethyl methacrylate, 2-(9-carbazolyl)-ethyl acrylate, and the polymers poly(2-(9-carbazolyl)-ethyl acrylate) and poly(2-(9-carbazolyl)-ethyl methacrylate) are also commercially available from various sources, such as Aldrich Chemical Company, Milwaukee, Wis.

In some embodiments, the polymer useful in the invention is a homopolymer. In other embodiments, the polymer is a copolymer and additionally includes structural units derived from (meth)acrylic acid, esters of (meth)acrylic acid, (meth)acrylic amides, vinyl aromatic monomers, substituted ethylene monomers, and combinations thereof. The copolymer may be a block copolymer, a random copolymer, an alternating copolymer, or a graft copolymer. The different kinds of copolymers may be obtained by the appropriate choice of monomers, reaction conditions such as initiators, temperature, and/or solvent.

Polymers useful in the invention may be made by the polymerization of monomers effected by initiators that include free radical initiators, cationic initiators, anionic initiators, and the like. Polymerization may be effected in the bulk state, in solution using a suitable solvent, or in an appropriate suspension or emulsion state. In one particular embodiment, the polymerization is effected using free radical initiators such as azobisisobutyronitrile in a nonpolar solvent such as benzene or toluene.

Methods for polymerizing (meth)acrylate monomers are well known in the art. In certain embodiments, the polymerization reaction may be conducted at a temperature that ranges from about −50° C. to about 100° C. The polymerization may also be conducted at atmospheric pressure, subatmospheric pressures, or superatmospheric pressures. The polymerization reaction is conducted for a time period necessary to achieve polymer of a suitable molecular weight. The molecular weight of a polymer is determined by any of the techniques known to those skilled in the art, and include viscosity measurements, light scattering, osmometry, and the like. The molecular weight of a polymer is typically represented as a number average molecular weight Mn, or weight average molecular weight, M_{w}. A particularly useful technique to determine molecular weight averages is gel permeation chromatography (GPC), from wherein both number average and weight average molecular weights are obtained. In some embodiments, it is desirable that M_{w} of the polymer is sufficiently high to allow film formation, typically greater than about 5,000 grams per mole (g/mol) is desirable, in other embodiments, polymers of M_{w} greater than 30,000 g/mol is desirable, while in yet other embodiments, polymer of M_{w} greater than 70,000 g/mol is desirable. M_{w} is determined using polystyrene as standard.

Phosphorescent organometallic compound for use in the compositions and devices of the present invention are of formula L₂MZ wherein L and Z are independently bidentate ligands; M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Ga, Ge, In, Sn, Sb, Tl, Pb, Bi, Eu, Tb, La, Po, or a combination thereof.

In one embodiment, M is iridium, and the phosphorescent organometallic compound is an organic iridium composition.

In some embodiments, L is a cyclometallated ligand. In some specific embodiments, L and Z are independently derived from phenylpyridine, tolylpyridine, benzothienylpyridine, phenylisoquinoline, dibenzoquinozaline, fluorenylpyridine, ketopyrrole, picolinate, acetylacetonate hexafluoroacetylacetonate, salicylidene, 8-hydroxyquinolinate; amino acid, salicylaldehyde, iminoacetonate, 2-(1-naphthyl)benzoxazole)), 2-phenylbenzaxazole, 2-phenylbenzothiazole, coumarin, thienylpyridine, phenylpyridine, benzothienylpyridine, 3-methoxy-2-phenylpyridine, thienylpyridine, phenylimine, vinylpyridine, pyridylnaphthalene, pyridylpyrrole, pyridylimidazole, phenylindole, derivatives thereof or combinations thereof.

In some embodiments, the at least one phosphorescent organometallic compound is a compound of formula

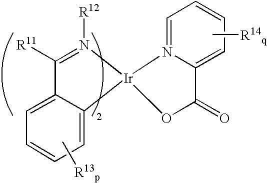

wherein R¹¹ and R¹² taken together form a substituted or unsubstituted monocyclic or bicyclic heteroaromatic ring; R¹³ and R¹⁴ are independently at each occurrence halo, nitro, hydroxy, amino, alkyl, aryl, arylalkyl, alkoxy, substituted alkoxy, substituted alkyl, substituted aryl, or substituted arylalkyl; p and q are independently 0, or integers ranging from 1 to 4. In particular embodiments, L is derived from a phenyl pyridine, and/or Z is derived from picolinate. In one specific embodiment, M is iridium, L is derived from 2-(4,6-difluorophenyl)pyridine, and Z is derived from picolinic acid, and the phosphorescent organometallic compound has formula

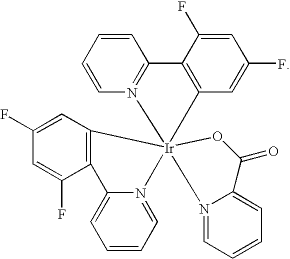

This organic iridium compound (FIrpic) is a known blue phosphorescent dye. This organic iridium composition is commercially available from various sources, such as American Dye Sources, Quebec, Canada. Alternately, it may be synthesized by first reacting the cyclometallating ligand 2-(4,6-difluorophenyl)pyridine with iridium (III) chloride under suitable reaction conditions to afford the chloride-bridged cyclometallated iridium dimer intermediate, followed by reacting the intermediate with picolinic acid under suitable reaction conditions to afford the organic iridium composition.

In some other embodiments, the phosphorescent dye may be a red phosphorescent dye, a green phosphorescent dye, a blue phosphorescent dye, or combinations thereof.

Exemplary blue phosphorescent dyes include, but are not limited to,

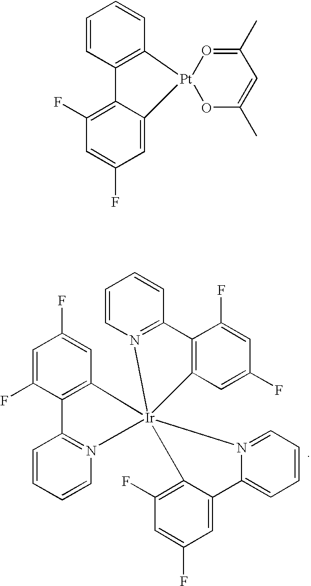

Exemplary green phosphorescent dyes include, but are not limited to,

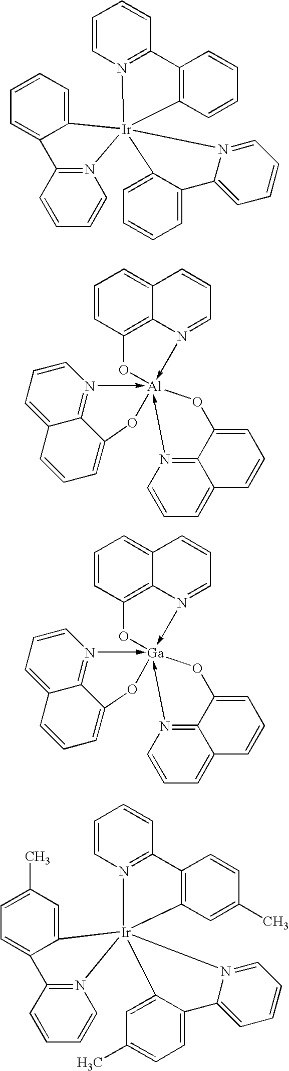

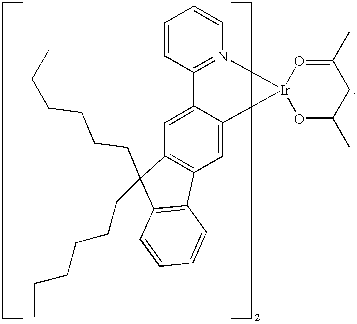

Exemplary red phosphorescent dyes include, but are not limited to,

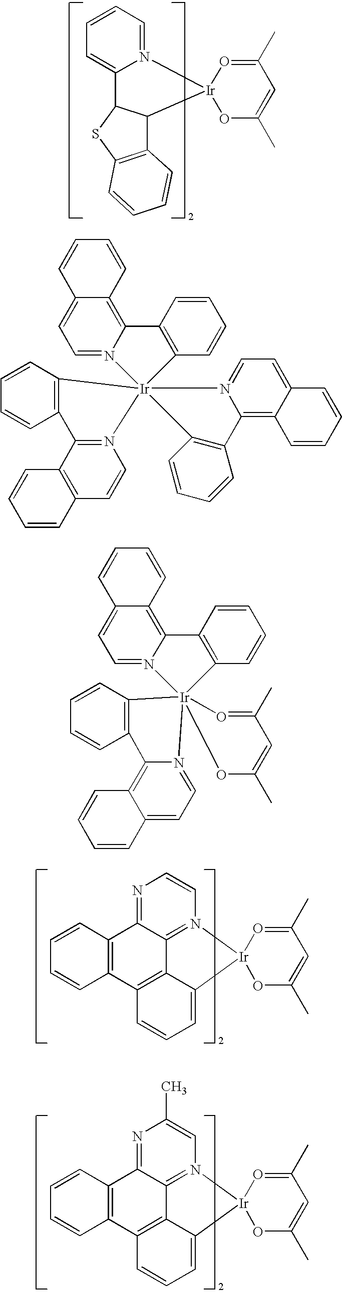

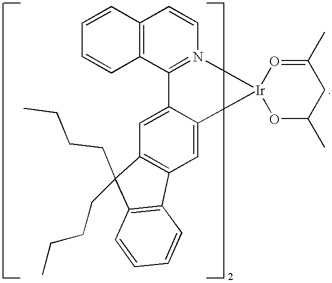

Phosphorescent organometallic compounds as described herein, may be synthesized by standard techniques as described earlier, or by other techniques known in the art. Alternately, the phosphorescent organometallic compounds of the invention may be obtained from commercial sources, such as American Dye Sources, Quebec, Canada.

In one embodiment, the at least one phosphorescent organometallic compound is present in an amount ranging from about 0.01 mole percent to about 25 mole percent with respect to the number of moles of the structural unit derived from the monomer of formula I. In another embodiment, the at least one phosphorescent organometallic compound is present in an amount ranging from about 0.1 mole percent to about 10 mole percent. Alternately, the amount of the organometallic compound may be expressed as weight percent of the total weight of the polymer; in such cases, the amount of the organometallic compound ranges from about 0.1 weight percent to about 40 weight percent.

In another aspect, the present invention relates to polymers that include structural units derived from a monomer of formula I, and a polymerizable phosphorescent organometallic compound of formula L′₂MZ′, wherein L′ and Z′ are independently bidentate ligands; at least one of L′ and Z′ comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl; and M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Ga, Ge, In, Sn, Sb, Tl, Pb, Bi, Eu, Tb, La, Po, or a combination thereof.

In some embodiments, M is Tc, Ru, Rh, Pd, Re, Os, Ir, Pt, or a combination thereof. In other embodiments, M is Ru, Pd, Os, Ir, Pt, or a combination thereof. In one specific embodiment, M is Ir and the polymerizable phosphorescent organometallic compound is an organic iridium composition.

In one embodiment, L′ is a cyclometallated ligand. In some embodiments, L′and Z′ are independently derived from phenylpyridine, tolylpyridine, benzothienylpyridine, phenylisoquinoline, dibenzoquinozaline, fluorenylpyridine, ketopyrrole, picolinate, acetylacetonate, hexafluoroacetylacetonate, salicylidene, 8-hydroxyquinolinate; amino acid, salicylaldehyde, iminoacetonate, 2-(1-naphthyl)benzoxazole)), 2-phenylbenzoxazole, 2-phenylbenzothiazole, coumarin, thienylpyridine, phenylpyridine, benzothienylpyridine, 3-methoxy-2-phenylpyridine, thienylpyridine, phenylimine, vinylpyridine, pyridylnaphthalene, pyridylpyrrole, pyridylimidazole, phenylindole, derivatives thereof or combinations thereof. In some other specific embodiments, L′ is derived from 1-phenylisoquinoline, 2-phenylpyridine, a derivative thereof, or a combination thereof.

In some specific embodiments, the polymerizable organometallic compound is a compound of formula

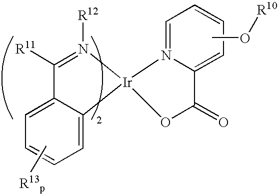

wherein R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy, styryl, acryloyl, methacryloyl or a combination thereof; R¹¹ and R¹² taken together form a substituted or unsubstituted monocyclic or bicyclic heteroaromatic ring; R¹³ is independently at each occurrence halo, nitro, hydroxy, amino, alkyl, aryl, arylalkyl, alkoxy, substituted alkoxy, substituted alkyl, substituted aryl, or substituted arylalkyl; and p is 0, or is an integer that ranges from 1 to 4. The group R¹⁰ is polymerizable group on the organometallic compound, and is a styryl group in one embodiment, a methacryloyl group in another embodiment, and an acryloyl group in yet another embodiment.

In particular embodiments, L′ is derived from a phenyl pyridine, and/or Z′ is derived from picolinate, and comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl. In one specific embodiment, M is iridium, L is derived from 2-(4,6-difluorophenyl)pyridine, and Z is derived from a hydroxypicolinic acid, and the polymerizable phosphorescent organometallic compound has formula compound of formula

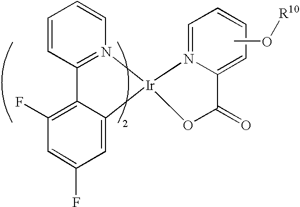

wherein R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy, styryl, acryloyl, methacryloyl or a combination thereof.

Polymerizable phosphorescent organometallic compounds of the invention may be prepared in a multistep process. Thus, in one embodiment, a first intermediate may be prepared by heating a ligand precursor, such as 2-(4,6-difluorophenyl)pyridine, with metal halide, such as IrCl₃, in the presence of a solvent such as aqueous 2-methoxyethanol, to afford the chloride-bridged cyclometallated iridium dimer intermediate (e.g. {(Fppy)₂Ir(μ-Cl)}₂). The chloride-bridged cyclometallated iridium dimer intermediate may be reacted with a functionalized ancillary ligand such as 4-hydroxy picolinic acid, in the presence of a base to afford the corresponding functionalized organic iridium complex. Subsequently, the organic iridium complex is reacted with a suitable organic reactant comprising a vinyl group and a functional group that can react with the functionalized organic iridium complex to provide the polymerizable phosphorescent organometallic compound. Some of the intermediates described herein may also be available from commercial sources, such as Aldrich Chemical Company, Milwaukee, Wis., or American Dye Sources, Quebec, Canada.

In one embodiment, the at least one polymerizable phosphorescent organometallic compound is present in an amount ranging from about 0.1 mole percent to about 25 mole percent with respect to the total number of moles of the monomer having formula I. In another embodiment, the at least one polymerizable phosphorescent organometallic compound is present in an amount ranging from about 1 mole percent to about 10 mole percent with respect to the total number of moles with respect to the total number of moles of monomer having formula I.

Compositions and polymers provided in the present invention may find use in a wide variety of applications that include, but are not limited to, light emitting electrochemical cells, photo detectors, photo conductive cells, photo switches, display devices and the like. Thus, in one aspect, the invention provides a light emitting comprising at least one electrode, at least one hole injection layer, at least one light emissive layer; wherein the light emissive layer comprises a composition comprising at least one phosphorescent organometallic compound and at least one polymer having structural units derived from at least one monomer of formula I. In another aspect, the invention provides a light emitting comprising at least one electrode, at least one hole injection layer, at least one light emissive layer; wherein the light emissive layer comprises a composition comprising at least one polymer having structural units derived from at least one monomer of formula I and structural units derived from a polymerizable phosphorescent organometallic compound.

The compositions of the present invention are particularly well suited for use in an electroactive layers in organic light emitting devices. In one embodiment, the present invention provides an organic light emitting device comprising an electroactive layer which consists essentially of a composition or polymer of the invention. In another embodiment, the present invention provides an organic light emitting device comprising the composition or polymer of the invention as a constituent of an electroactive layer of an organic light emitting device. In one embodiment, the present invention provides an organic light emitting device comprising the composition or polymer of the invention as a constituent of a light emitting electroactive layer of an organic light emitting device.

An organic light emitting device typically comprises multiple layers which include in the simplest case, an anode layer and a corresponding cathode layer with an organic electroluminescent layer disposed between said anode and said cathode. When a voltage bias is applied across the electrodes, electrons are injected by the cathode into the electroluminescent layer while electrons are removed from (or “holes” are “injected” into) the electroluminescent layer from the anode. Light emission occurs as holes combine with electrons within the electroluminescent layer to form singlet or triplet excitons, light emission occurring as singlet excitons transfer energy to the environment by radiative decay.

Other components which may be present in an organic light emitting device in addition to the anode, cathode, and light emitting material include hole injection layers, electron injection layers, and electron transport layers. The electron transport layer need not be in contact with the cathode, and frequently the electron transport layer is not an efficient hole transporter and thus it serves to block holes migrating toward the cathode. During operation of an organic light emitting device comprising an electron transport layer, the majority of charge carriers (i.e. holes and electrons) present in the electron transport layer are electrons and light emission can occur through recombination of holes and electrons present in the electron transport layer. Additional components which may be present in an organic light emitting device include hole transport layers, hole transporting emission (emitting) layers and electron transporting emission (emitting) layers.

Polymers comprising structural units derived from monomers of formula I have triplet energy states that are useful in applications such as organic light emitting devices (OLEDs), as they may give rise to highly efficient devices. Further, the triplet energy of these polymers may be high enough that it may be greater than those of the phosphorescent dyes used in devices, and thus may serve as host molecules.

The organic electroluminescent layer is a layer within an organic light emitting device which when in operation contains a significant concentration of both electrons and holes and provides sites for exciton formation and light emission. A hole injection layer is a layer in contact with the anode which promotes the injection of holes from the anode into the interior layers of the OLED; and an electron injection layer is a layer in contact with the cathode that promotes the injection of electrons from the cathode into the OLED; an electron transport layer is a layer which facilitates conduction of electrons from cathode to a charge recombination site. The electron transport layer need not be in contact with the cathode, and frequently the electron transport layer is not an efficient hole transporter and thus it serves to block holes migrating toward the cathode. During operation of an organic light emitting device comprising an electron transport layer, the majority of charge carriers (i.e. holes and electrons) present in the electron transport layer are electrons and light emission can occur through recombination of holes and electrons present in the electron transport layer. A hole transport layer is a layer which when the OLED is in operation facilitates conduction of holes from the anode to charge recombination sites and which need not be in contact with the anode. A hole transporting emission layer is a layer in which when the OLED is in operation facilitates the conduction of holes to charge recombination sites, and in which the majority of charge carriers are holes, and in which emission occurs not only through recombination with residual electrons, but also through the transfer of energy from a charge recombination zone elsewhere in the device. An electron transporting emission layer is a layer in which when the OLED is in operation facilitates the conduction of electrons to charge recombination sites, and in which the majority of charge carriers are electrons, and in which emission occurs not only through recombination with residual holes, but also through the transfer of energy from a charge recombination zone elsewhere in the device.

Materials suitable for use as the anode include materials having a bulk conductivity of at least about 100 ohms per square, as measured by a four-point probe technique. Indium tin oxide (ITO) is frequently used as the anode because it is substantially transparent to light transmission and thus facilitates the escape of light emitted from electro-active organic layer. Other materials which may be utilized as the anode layer include tin oxide, indium oxide, zinc oxide, indium zinc oxide, zinc indium tin oxide, antimony oxide, and mixtures thereof.

Materials suitable for use as the cathode include by zero valent metals which can inject negative charge carriers (electrons) into the inner layer(s) of the OLED. Various zero valent metals suitable for use as the cathode include K, Li, Na, Cs, Mg, Ca, Sr, Ba, Al, Ag, Au, In, Sn, Zn, Zr, Sc, Y, elements of the lanthanide series, alloys thereof, and mixtures thereof. Suitable alloy materials for use as the cathode layer include Ag—Mg, Al—Li, In—Mg, Al—Ca, and Al—Au alloys. Layered non-alloy structures may also be employed in the cathode, such as a thin layer of a metal such as calcium, or a metal fluoride, such as LiF, covered by a thicker layer of a zero valent metal, such as aluminum or silver. In particular, the cathode may be composed of a single zero valent metal, and especially of aluminum metal.

Materials suitable for use in hole transporting layers include 1,1-bis((di-4-tolylamino)phenyl)cyclohexane, N,N′-bis(4-methylphenyl)-N,N′-bis(4-ethylphenyl)-(1,1′-(3,3′-dimethyl)biphenyl)-4,4′-diamine, tetrakis-(3-methylphenyl)-N,N,N′,N′-2,5-phenylenediamine, phenyl-4-N,N-diphenylaminostyrene, p-(diethylamino)benzaldehyde diphenylhydrazone, triphenylamine, 1-phenyl-3-(p-(diethylamino)styryl)-5-(p-(diethylamino)phenyl)pyrazoline, 1,2-trans-bis(9H-carbazol-9-yl)cyclobutane, N,N,N′,N′-tetrakis(4-methylphenyl)-(1,1′-biphenyl)-4,4′-diamine, copper phthalocyanine, polyvinylcarbazole, (phenylmethyl)polysilane; poly(3,4-ethylendioxythiophene) (PEDOT), polyaniline, polyvinylcarbazole, triaryldiamine, tetraphenyldiamine, aromatic tertiary amines, hydrazone derivatives, carbazole derivatives, triazole derivatives, imidazole derivatives, oxadiazole derivatives having an amino group, and polythiophenes as disclosed in U.S. Pat. No. 6,023,371.

Materials suitable for use as the electron transport layer include poly(9,9-dioctyl fluorene), tris(8-hydroxyquinolato) aluminum (Alq₃), 2,9-dimethyl-4,7-diphenyl-1,1-phenanthroline, 4,7-diphenyl-1,10-phenanthroline, 2-(4-biphenylyl)-5-(4-t-butylphenyl)-1,3,4-oxadiazole, 3-(4-biphenylyl)-4-phenyl-5-(4-t-butylphenyl)-1,2,4-triazole, 1,3,4-oxadiazole-containing polymers, 1,3,4-triazole-containing polymers, quinoxaline-containing polymers, and cyano-PPV.

### Definitions

In the context of the present invention, alkyl is intended to include linear, branched, or cyclic hydrocarbon structures and combinations thereof, including lower alkyl and higher alkyl. Preferred alkyl groups are those of C₂₀ or below. Lower alkyl refers to alkyl groups of from 1 to 6 carbon atoms, preferably from 1 to 4 carbon atoms, and includes methyl, ethyl, n-propyl, isopropyl, and n-, s- and t-butyl. Higher alkyl refers to alkyl groups having seven or more carbon atoms, preferably 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, and norbornyl. Alkenyl and alkynyl refer to alkyl groups wherein two or more hydrogen atoms are replaced by a double or triple bond, respectively.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0-3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen. Examples include methoxy, ethoxy, propoxy, isopropoxy, cyclopropyloxy, and cyclohexyloxy. Lower alkoxy refers to groups containing one to four carbons.

Acyl refers to groups of from 1 to 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include acetyl, benzoyl, propionyl, isobutyryl, t-butoxycarbonyl, and benzyloxycarbonyl. Lower-acyl refers to groups containing one to four carbons.

Heterocycle means a cycloalkyl or aryl residue in which one to three of the carbons is replaced by a heteroatom such as oxygen, nitrogen or sulfur. Examples of heterocycles that fall within the scope of the invention include pyrrolidine, pyrazole, pyrrole, indole, quinoline, isoquinoline, tetrahydroisoquinoline, benzofuran, benzodioxan, benzodioxole (commonly referred to as methylenedioxyphenyl, when occurring as a substituent), tetrazole, morpholine, thiazole, pyridine, pyridazine, pyrimidine, thiophene, furan, oxazole, oxazoline, isoxazole, dioxane, and tetrahydrofuran, triazole, benzotriazole, and triazine.

Substituted refers to structural units, including, but not limited to, alkyl, alkylaryl, aryl, arylalkyl, and heteroaryl, wherein up to three H atoms of the residue are replaced with lower alkyl, substituted alkyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy; each of said phenyl, benzyl, phenoxy, benzyloxy, heteroaryl, and heteroaryloxy is optionally substituted with 1-3 substituents selected from lower alkyl, alkenyl, alkynyl, halogen, hydroxy, haloalkyl, alkoxy, cyano, phenyl, benzyl, benzyloxy, carboxamido, heteroaryl, heteroaryloxy, nitro or —NRR (wherein R is independently H, lower alkyl or cycloalkyl, and —RR may be fused to form a cyclic ring with nitrogen).

Haloalkyl refers to an alkyl residue, wherein one or more H atoms are replaced by halogen atoms; the term haloalkyl includes perhaloalkyl. Examples of haloalkyl groups that fall within the scope of the invention include CH₂F, CHF₂, and CF₃.

Silyl means an alkyl residue in which one to three of the carbons is replaced by tetravalent silicon and which is attached to the parent structure through a silicon atom. Siloxy is an alkoxy residue in which both of the carbons are replaced by tetravalent silicon that is endcapped with an alkyl residue, aryl residue or a cycloalkyl residue, and which is attached to the parent structure through an oxygen atom.

A bidentate ligand is a ligand that is capable of binding to metals through two sites. Similarly, a tridentate ligand is a ligand that is capable of binding to metals through three sites. Cyclometallated ligand means a bidentate or tridentate ligand bound to a metal atom by a carbon-metal single bond and one or two metal-heteroatom bonds, forming a cyclic structure, wherein the heteroatom may be N, S, P, As, or O.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

### Experimental

General: Molecular weight data was obtained using Perkin-Elmer GPC Series 200 with UV/VIS Detector, Polymer Laboratories PLGel 5 mm column, Chloroform as eluent, and polystyrene standards as the calibration standards. NMR spectroscopy was performed on Bruker 400 MHz instrument. Glass pre-coated with indium tin oxide (ITO) was obtained from Applied Films. Poly(3,4-ethylendioxythiophene)/polystyrene sulfonate (PEDOT:PSS) was purchased from H.C. Starck Co., GmbH, Leverkusen, Germany.

(3,5-Bis(4-tert-butyl-phenyl)-4-phenyl-[1,2,4]triazole) (TAZ) purchased from H.W. Sands was used as an electron transport material.

### EXAMPLE 1

### Synthesis of (F₂ppy)₂Ir(3-hydroxypicolinate)

A 100 mL glass Wheaton vial was charged with sodium carbonate (2.4 g, 22.6 mmoles, Aldrich), 3-hydroxypicolinic acid (0.90 g, 6.5 mmoles, Aldrich), and [(F₂ppy)₂IrCl]₂ (2.5 g, 2.05 mmoles, American Dye Source) and then dissolved in 50 mL DMF (Aldrich). After addition of a 1 inch magnetic stir bar, the vial was sealed with a crimp cap and purged with nitrogen by syringe for 10 minutes. After letting the solution stir for another 10 minutes, the initially yellow color took on an orange hue whereupon it was placed into a pre-heated (85° C.) oil bath overnight. The orange reaction mixture was cooled to room temperature and poured into water (500 mL). The aqueous mixture was extracted (3×50 mL) with ethyl acetate and dried over sodium sulfate. After concentrating by rotary evaporation, the orange residue was dissolved in a minimum of chloroform and re-crystallized with hexane. The product was collected by filtration and dried in vacuo. Yield (2 g, 68%). ¹H NMR (400 MHz, d₆-DMSO, 25° C.) δ 5.48 (dd, 1H), 5.66 (dd, 1H), 6.82 (m, 2H), 7.24 (d, 1H), 7.35 (t, 1H), 7.5 (m, 1H), 7.62 (d, 1H), 7.7 (d, 1H), 7.96 (s, 1H), 8.09 (m, 2H), 8.23 (m, 2H), 8.5 (d, 1H), 13.56 (s, 1H).

### EXAMPLE 2

### Synthesis (F₂ppy)₂Ir(3-styryletherpicolinate)

A 50 mL glass Wheaton vial was charged with potassium carbonate (2.3 grams (g), 14.4 millimoles (mmoles)), tetrabutylammonium iodide (0.10 g, 0.27 mmoles), 4-chloromethylstyrene (0.717 g, 4.7 mmoles), and (F₂ppy)₂Ir(3-hydroxypicolinate) (1.55 g, 2.18 mmoles) and then dissolved in 15 milliliters (mL) dimethyl formamide (DMF). After addition of a ½ inch magnetic stir bar, the vial was sealed with a crimp cap and purged with nitrogen by syringe for 10 minutes. After allowing the solution stir for another 10 minutes, the initially yellow color took on an orange hue whereupon it was placed into an oil-bath that was pre-heated to 85° C. for 2 hours. The orange reaction mixture was cooled to room temperature and poured into water (100 mL). The precipitated product was collected by filtration and purified by flash chromatography (silica gel, gradient elution, hexanes to 100% ethyl acetate). The product fractions were combined and concentrated. The concentrate was dissolved in a minimum of chloroform and then re-crystallized from hexane. The yellow crystalline product was collected by filtration and dried in vacuo. Yield (1.3 g, 71%). ¹H NMR (400 MHz, d₆-DMSO, 25° C.) δ 5.27 (d, 1H), 5.29 (s, 2H) 5.46 (dd, 1H), 5.68 (dd, 1H), 5.86 (d, 1H), 6.76-6.87 (m, 3H), 7.36 (m, 2H), 7.5-7.58 (m, 6H), 7.68 (d, 1H), 7.91 (d, 1H), 8.05 (dt, 2H), 8.23 (d, 1H), 8.29 (d, 1H), 8.59 (d, 1H).

### EXAMPLE 3

### Synthesis of (F₂ppy)₂Ir(5-hydroxypicolinate)

A 100 mL glass Wheaton vial was charged with sodium carbonate (2.4 g, 22.6 mmoles, Aldrich), 5-hydroxypicolinic acid (0.96 g, 6.9 mmoles, Synchem Ltd), and [(F₂ppy)₂IrCl]₂ (2.72 g, 2.2 mmoles, American Dye Source) and then dissolved in 50 mL DMF (Aldrich). After addition of a 1-inch magnetic stir bar, the vial was sealed with a crimp cap and purged with nitrogen by syringe for 10 minutes. After allowing the solution stir for another 10 minutes, the initially yellow color took on an orange hue whereupon it was placed into a pre-heated (85° C.) oil bath overnight. The orange reaction mixture was cooled to room temperature and poured into water (500 mL) causing some of the product to precipitate. The solids were collected by filtration and set aside. The aqueous fraction was extracted with chloroform, dried over sodium sulfate, and concentrated. The concentrate and initial solid precipitate were combined and dissolved in a minimum of chloroform and then re-crystallized with hexane. The yellow crystalline product was collected by filtration and dried in vacuo. Yield (2.17 g, 68%). ¹H NMR (400 MHz, d₆-DMSO, 25° C.) δ 5.47 (dd, 1H), 5.69 (d, 1H), 6.8 (m, 2H), 7.23 (d, 1H), 7.34 (t, 1H) 7.42 (dd, 1H), 7.5 (t, 1H), 7.68 (d, 1H), 7.95 (s, 1H), 8.04 (m, 2H), 8.26 (t, 2H), 8.54 (d, 1H), 11.1 (s, 1H).

### EXAMPLE 4

### Synthesis of (F₂ppy)₂Ir(5-(9-hydroxy nonyl)picolinate)

In a three neck round bottom flask equipped with a Dean-Stark trap, 0.37 g of (F₂ppy)₂Ir(5-hydroxypicolinate) and 0.4 g of K₂CO₃ was added together into 20 mL of DMF. Then, 3 mL of toluene was added and reaction was heated to 120° C. to azeotropically remove water. After all the toluene was removed, 0.5 g of 1-bromo-nonanol was added, along with 0.1 g of tetrabutyl ammonium iodide. Reaction mixture was kept at 120° C. for 12 hours. After cooling to room temperature, ethylacetate (30 mL) and water (30 mL) was added. Organic and aqueous phase were separated and organic phase was further extracted with water (30 mL×2) and brine (30 mL×1). Subsequently, the organic phase was dried over MgSO₄. Solvent was then removed in vacuo. Column chromatography on silica gel using CH₂Cl₂/MeOH as eluting solvent afforded 0.2 84 g of viscous solid as product. ¹H(CDCl₃) δ 8.75 (s, 1H), 8.26 (m, 3H), 7.78 (s, 2H), 7.47 (d, 1H), 7.37 (d, 1H), 7.36 (s, 1H), 7.20 (t, 1H), 7.00 (t, 1H), 6.49 (t, 1H), 6.39 (t, 1H), 5.83 (d, 1H), 5.56 (d, 1H), 3.89 (t, 2H), 3.63 (t, 2H), 1.73 (t, 2H), 1.56 (t, 2H), 1.30 (broad peak, 10H).

### EXAMPLE 5

### Synthesis of (F₂ppy)₂Ir(5-(9-nonyl acrylate)picolinate)

In a round bottom flask, 0.284 g of (F₂ppy)₂Ir(5-(9-hydroxy nonyl)picolinate) was dissolved in 15 mL of dry methylene chloride. The solution was purged with argon and 250 μl of acryloyl chloride was added. This reaction mixture was chilled in an ice water bath, and 250 μl of triethylamine was added using a syringe in a drop wise fashion. After 0.5 hour, the ice/water bath was removed and reaction was stirred at room temperature overnight. Methylene chloride was removed and ether (20 mL) was used to extract the solid. After concentrating, the crude product was load on a silica gel column and purified using CH₂Cl₂/MeOH as the eluting solvent to afford 0.13 g of yellow solid as product. ¹H(CDCl₃) δ 8.77 (s, 1H), 8.29 (m, 3H), 7.80 (t, 2H), 7.49 (d, 1H), 7.39 (d, 1H), 7.21 (t, 1H), 7.01 (t, 1H), 6.51 (t, 1H), 6.42 (d, 1H), 6.41 (t, 1H), 6.14 (dd, 1H), 5.86 (d, 1H), 5.84 (d, 1H), 5.57 (d, 1H), 4.16 (t, 2H), 3.91 (t, 2H), 1.75 (t, 2H), 1.68 (t, 2H), 1.30 (broad peak, 10H).

### EXAMPLE 6

### Synthesis of (F₂ppy)₂Ir(3-hydroxypicolinate)

A 100 mL glass Wheaton vial was charged with sodium carbonate (2.4 g, 22.6 mmoles, Aldrich), 3-hydroxypicolinic acid (0.90 g, 6.5 mmoles, Aldrich), and [(F₂ppy)₂IrCl]₂ (2.5 g, 2.05 mmoles, American Dye Source) and then dissolved in 50 mL DMF (Aldrich). After addition of a 1 inch magnetic stir bar, the vial was sealed with a crimp cap and purged with nitrogen by syringe for 10 minutes. After letting the solution stir for another 10 minutes, the initially yellow color took on an orange hue whereupon it was placed into a pre-heated (85° C.) oil bath overnight. The orange reaction mixture was cooled to room temperature and poured into water (500 mL). The aqueous mixture was extracted (3×50 mL) with ethyl acetate and dried over sodium sulfate. After concentrating by rotary evaporation, the orange residue was dissolved in a minimum of chloroform and re-crystallized with hexane. The product was collected by filtration and dried in vacuo. Yield (2 g, 68%). ¹H NMR (400 MHz, d₆-DMSO, 25° C.) δ 5.48 (dd, 1H), 5.66 (dd, 1H), 6.82 (m, 2H), 7.24 (d, 1H), 7.35 (t, 1H), 7.5 (m, 1H), 7.62 (d, 1H), 7.7 (d, 1H), 7.96 (s, 1H), 8.09 (m, 2H), 8.23 (m, 2H), 8.5 (d, 1H), 13.56 (s, 1H).

### EXAMPLE 7

### Synthesis of (F₂ppy)₂Ir(3-styryletherpicolinate)

A 50 mL glass Wheaton vial was charged with potassium carbonate (2.3 g, 14.4 mmoles, Aldrich), tetrabutylammonium iodide (00.10 g, 0.27 mmoles, Aldrich), 4-chloromethylstyrene (0.717 g, 4.7 mmoles, Aldrich), and (F₂ppy)₂Ir(3-hydroxypicolinate) (1.55 g, 2.18 mmoles) and then dissolved in 15 mL DMF (Aldrich). After addition of a ½ inch magnetic stir bar, the vial was sealed with a crimp cap and purged with nitrogen by syringe for 10 minutes. After allowing the solution stir for another 10 minutes, the initially yellow color took on an orange hue whereupon it was placed into a pre-heated (85° C.) oil bath for 2 hours. The orange reaction mixture was cooled to room temperature and poured into water (100 mL). The precipitated product was collected by filtration and purified by flash chromatography (silica gel, gradient elution, hexanes to 100% ethyl acetate). The product fractions were combined and concentrated. The concentrate was dissolved in a minimum of chloroform and then re-crystallized with hexane. The yellow crystalline product was collected by filtration and dried in vacuo. Yield (1.3 g, 71%). ¹H NMR (400 MHz, d₆-DMSO, 25° C.) δ 5.27 (d, 1H), 5.29 (s, 2H) 5.46 (dd, 1H), 5.68 (dd, 1H), 5.86 (d, 1H), 6.76-6.87 (m, 3H), 7.36 (m, 2H), 7.5-7.58 (m, 6H), 7.68 (d, 1H), 7.91 (d, 1H), 8.05 (dt, 2H), 8.23 (d, 1H), 8.29 (d, 1H), 8.59 (d, 1H).

### EXAMPLE 8

### Synthesis of (F₂ppy)₂Ir(3-acryloylpicolinate)

A 20 mL glass Wheaton vial was charged with (F₂ppy)₂Ir(3-hydroxypicolinate) (0.25 g, 0.35 mmoles) and then dissolved in 10 mL chloroform (Aldrich). After addition of a ½ inch magnetic stir bar, acryloyl chloride (200 mg, 2.2 mmoles) and 0.5 mL of triethylamine (3.6 mmoles) were added by pipette. The vial was sealed with a crimp and stirred overnight at room temperature. The orange reaction mixture was concentrated and purified by flash chromatography (silica gel, gradient elution, chloroform:methanol 97:3 ratio). The product fraction was concentrated, taken up in minimum of chloroform and re-crystallized from hexanes. The yellow crystalline product was collected by filtration and dried in vacuo. Yield (144 mg, 54%). ¹H NMR (400 MHz, d₆-DMSO, 25° C.) δ 5.44 (dd, 1H), 5.68 (dd, 1H), 6.18 (d, 1H), 6.39-6.54 (m, 2H), 6.8-6.9 (m, 2H), 7.35 (t, 1H), 7.52 (t, 1H), 7.65-7.77 (m, 3H), 8.0-8.11 (m, 3H), 8.28 (m, 2H), 8.50 (d, 1H).

### EXAMPLE 9

### General procedure for the synthesis of Poly(9H-carbazole-9-ethyl methacrylate-co-(F₂ppy)₂Ir(3-styryletherpicolinate))]

Vinyl monomers were weighed out in an amber vial. (Actual amounts are shown in Table 1.) To this vial, appropriate amount of N-methylpyrrolidinone (NMP) was added together with azobisisobutyronitrile (AIBN) in NMP solution (0.1 g/mL). Reaction mixture was stirred at room temperature until all styrenic FIrpic completely dissolved. The reaction mixture was carefully transferred to a Shlenk flask using a transfer pipette and 1 mL of NMP was used to rinse the flask and pipette. The Shlenk flask was degassed three times using freeze-thaw cycle, and was placed into an oil bath at 65° C. The reaction mixture was stirred overnight after which it was cooled to room temperature. Methylene chloride was added to flask to dilute the solution if necessary. Then, this mixture was added drop wise to 10 volume excess of methanol while stirring, during which time the polymer precipitated as a white powder, which was then collected through vacuum filtration. The collected polymer was redissolved into methylene chloride and reprecipitated out from acetone. Again the polymer was collected using vacuum filtration and further dried in a vacuum oven at 50° C. overnight. The amount of FIrpic was calculated from wt % of Ir in the polymer, which was experimentally determined by Solution Nebulization Inductively Coupled Plasma Emission Spectrometry (ICP-AES, Varian Liberty II). Details of the copolymers synthesized are given in table 1.

TABLE 1
Details of copolymers synthesized

| | Mass of | | wt % of Firpic | | | | | |
|---|---|---|---|---|---|---|---|---|
| Reaction | vinyls (g) | | | Analyzed | | Mw | | Yield |
| number | Dye | Host | Calc | Low | High | (×10⁻³) | PDI | (g) |
| 275-44-1 | 0.0847 | 0.1037 | 44.96 | 40.24 | 42.83 | 106 | 2.47 | 0.118 |
| 275-44-2 | 0.104 | 0.418 | 19.92 | 17.35 | 18.46 | 32.9 | 1.5 | 0.249 |
| 275-44-3 | 0.0807 | 0.4 | 16.79 | 15.14 | 15.88 | 110 | 3.04 | 0.354 |
| 275-44-4 | 0.058 | 0.4 | 12.66 | 10.34 | 11.45 | 121.8 | 2.69 | 0.38 |
| 275-44-5 | 0.051 | 0.3975 | 11.37 | 9.97 | 11.08 | 77.6 | 2.09 | 0.33 |
| 275-44-6 | 0.0385 | 0.4 | 8.78 | 7.38 | 8.49 | 73.3 | 1.93 | 0.31 |
| 275-44-7 | 0.070318 | 0.418 | 14.35 | 13.29 | 14.03 | 53.074 | 4.4 | 0.148 |
| 275-44-8 | 0.114132 | 0.4 | 22.00 | 20.31 | 21.41 | 169.7 | 4.85 | 0.31 |
| 275-44-9 | 0.15325 | 0.4 | 27.10 | 25.48 | 26.21 | 61.087 | 1.94 | 0.46 |

### EXAMPLE 10

### Phosphorescent OLEDs Based on Polymer Made from Reaction Number 275-44-3

The organic light emitting diodes (OLEDs) were made in the following manner: Pre-patterned ITO coated glass used as the anode substrate was cleaned with UV-ozone for 10 minutes (mins). Then a 60 nanometer (nm) layer PEDOT:PSS was deposited atop the ITO via spin-coating and then baked for 1 hour at 180° C. in air. The substrates were then transferred into a glove box filled with argon (both moisture and oxygen were less than 1 ppm). An emissive layer of polymer made from reaction number 275-44-3 was then spin-coated from its 1 weight percent (wt %) solution in chlorobenzene atop the PEDOT:PSS layer and baked on a hotplate pre-heated to 120° C. for 10 mins. Next, a layer of 40 nm TAZ was thermally evaporated on top of the emissive layer under a base vacuum of 2×10⁻⁶ Torr, followed by evaporation of a CsF(4 nanometer)/Al (130 nanometer) bilayer cathode. After metallization, the devices were encapsulated with a cover glass sealed with an optical adhesive Norland 68 obtained from Norland products, Inc, Cranbury, NJ 08512, USA. The active area was about 0.2 cm².

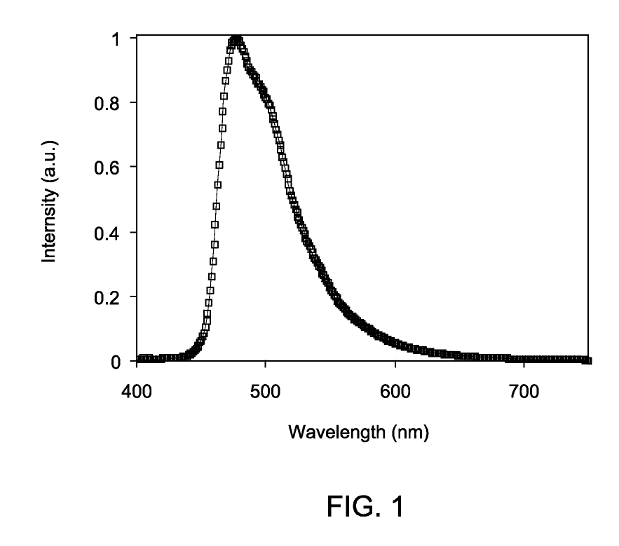

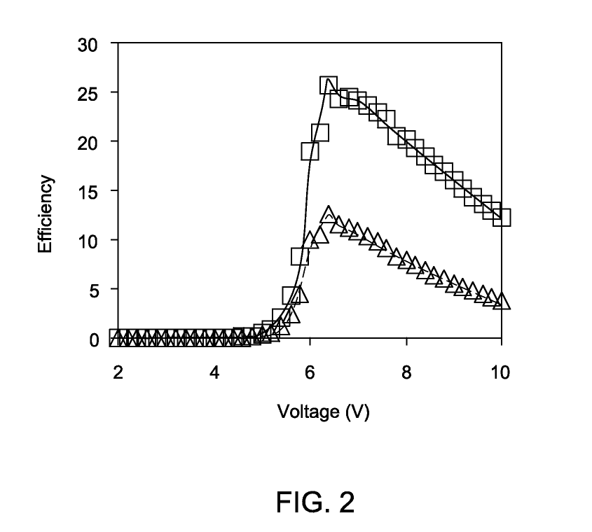

The OLEDs emit a sky-blue color with a CIE (‘Commission Internationale de l'Eclairage’) coordinate of (0.166, 0.365) as seen from the emission spectrum shown in FIG. 1. Device performance is depicted in FIG. 2. The OLED exhibited a maximum current efficiency of 25.7 cd/A and a maximum power efficiency of 12.6 1 m/w.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A polymer derived from a monomer of formula I 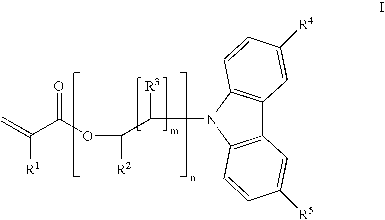
and a polymerizable phosphorescent organometallic compound of formula L′₂MZ′
wherein
R¹ is H or CH₃;
R² is H or C₁-C₅ alkyl;
R³ is H or CH₃;
R⁴ and R⁵ are independently H, CH₃, t-butyl, triarylsilyl, trialkylsilyl, diphenyl phosphine oxide, or diphenyl phosphine sulfide;
m ranges from 1 to about 20;
n ranges from 1 to about 20;
L′ and Z′ are independently bidentate ligands; and
at least one of L′ and Z′ comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl; and
M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Ga, Ge, In, Sn, Sb, Tl, Pb, Bi, Eu, Tb, La, Po, or a combination thereof.

2. A polymer according to claim 1, wherein R¹ is H.

3. A polymer according to claim 1, wherein R¹ is CH₃.

4. A polymer according to claim 1, wherein L′ is a cyclometallated ligand.

5. A polymer according to claim 1, wherein M is Tc, Ru, Rh, Pd, Re, Os, Ir, Pt, or a combination thereof.

6. A polymer according to claim 1, wherein M is Ru, Pd, Os, Ir, Pt, or a combination thereof.

7. A polymer according to claim 1, wherein M is Ir.

8. A polymer according to claim 1, wherein L′ and Z′ are independently derived from phenylpyridine, tolylpyridine, benzothienylpyridine, phenylisoquinoline, dibenzoquinozaline, fluorenylpyridine, ketopyrrole, picolinate, acetylacetonate hexafluoroacetylacetonate, salicylidene, 8-hydroxyquinolinate; amino acid, salicylaldehyde, iminoacetonate, 2-(1-naphthyl)benzoxazole)), 2-phenyl-benzoxazole, 2-phenylbenzothiazole, coumarin, thienylpyridine, phenylpyridine, benzothienylpyridine, 3-methoxy-2-phenylpyridine, thienylpyridine, phenylimine, vinylpyridine, pyridylnaphthalene, pyridylpyrrole, pyridylimidazole, phenylindole, derivatives thereof, or combinations thereof.

9. A polymer according to claim 1, wherein L′ is derived from 1-phenylisoquinoline, 2-phenylpyridine, a derivative thereof, or a combination thereof.

10. A polymer according to claim 1, wherein L′ is derived from 2-(4,6-difluorophenyl)pyridine.

11. A polymer according to claim 1, wherein Z′ is derived from picolinate, and comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl.

12. A polymer according to claim 1, wherein the polymerizable phosphorescent organometallic compound is a compound of formula 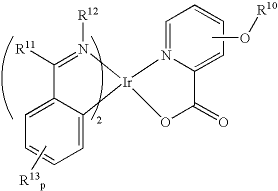
wherein
R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy; stryryl, acryloyl, methacryloyl or a combination thereof;
R¹¹ and R¹² taken together form a substituted or unsubstituted monocyclic or bicyclic heteroaromatic ring;
R¹³ is independently at each occurrence halo, nitro, hydroxy, amino, alkyl, aryl, arylalkyl, alkoxy, substituted alkoxy, substituted alkyl, substituted aryl, or substituted arylalkyl; and
p is 0, or an integer ranging from 1 to 4.

13. A polymer according to claim 12, wherein R¹⁰ is styryl.

14. A polymer according to claim 12, wherein R¹⁰ is acryloyl or methacryloyl.

15. A polymer according to claim 1, wherein the polymerizable phosphorescent organometallic compound is a compound of formula 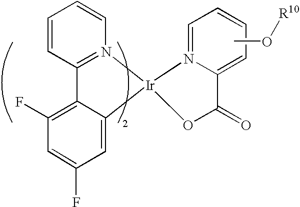
wherein
R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy, stryryl, acryloyl, methacryloyl or a combination thereof.

16. A polymer of claim 1, further comprising structural units derived from (meth)acrylic acid, esters of (meth)acrylic acid, (meth)acrylic amides, vinyl aromatic monomers, substituted ethylene monomers, and combinations thereof.

17. A polymer according to claim 1, wherein the polymerizable phosphorescent organometallic compound is a compound of formula 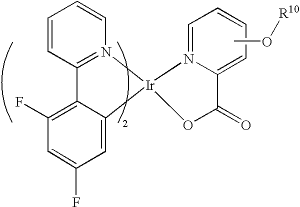
R¹⁰ is styryl, acryloyl, methacryloyl or a combination thereof; and
the polymer comprises structural units derived from a monomer selected from

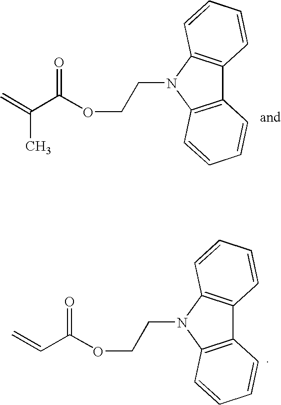

18. An organic light emitting device comprising:
at least one electrode,
at least one charge injection layer, and
at least one light emissive layer comprising a polymer derived from a monomer of formula I and a polymerizable phosphorescent organometallic compound of formula L′₂MZ′, 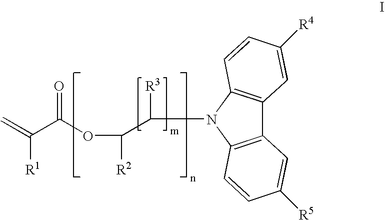
wherein
R¹ is H or CH₃;
R² is H or C₁-C₅ alkyl;
R³ is H or CH₃;
R⁴ and R⁵ are independently H, CH₃, t-butyl, triarylsilyl, trialkylsilyl, diphenyl phosphine oxide, or diphenyl phosphine sulfide;
m ranges from 1 to about 20;
n ranges from 1 to about 20;
L′ and Z′ are independently bidentate ligands;
at least one of L′ and Z′ comprises at least one substitutent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl; and
M is Ga, Al, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Ga, Ge, In, Sn, Sb, Tl, Pb, Bi, Eu, Tb, La, Po, or a combination thereof.

19. A device according to claim 18, wherein R¹ is H.

20. A device according to claim 18, wherein R¹ is CH₃.

21. A device according to claim 18, wherein L′ is a cyclometallated ligand.

22. A device according to claim 18, wherein M is Tc, Ru, Rh, Pd, Re, Os, Ir, Pt, or a combination thereof.

23. A device according to claim 18, wherein M is Ru, Pd, Os, Ir, Pt, or a combination thereof.

24. A device according to claim 18, wherein M is Ir.

25. A device according to claim 18, wherein L′ and Z′ are independently derived from phenylpyridine, tolylpyridine, benzothienylpyridine, phenylisoquinoline, dibenzoquinozaline, fluorenylpyridine, ketopyrrole, picolinate, acetylacetonate hexafluoroacetylacetonate, salicylidene, 8-hydroxyquinolinate; amino acid, salicylaldehyde, iminoacetonate, 2-(1-naphthyl)benzoxazole)), 2-phenylbenzoxazole, 2-phenylbenzothiazole, coumarin, thienylpyridine, phenylpyridine, benzothienylpyridine, 3-methoxy-2-phenylpyridine, thienylpyridine, phenylimine, vinylpyridine, pyridylnaphthalene, pyridylpyrrole, pyridylimidazole, phenylindole, derivatives thereof or combinations thereof.

26. A device according to claim 18, wherein L′ is derived from 1-phenylisoquinoline, 2-phenylpyridine, a derivative thereof, or a combination thereof.

27. A device according to claim 18, wherein L′ is derived from 2-(4,6-difluorophenyl)pyridine.

28. A device according to claim 18, wherein Z′ is derived from picolinate, and comprises at least one substituent selected from C₂₋₂₀ alkenyl, C₂₋₂₀ alkynyl, C₂₋₂₀ substituted alkenyl, C₂₋₂₀ substituted alkynyl, C₂₋₂₀ alkenyloxy, C₂₋₂₀ alkynyloxy, styryl, acryloyl, and methacryloyl.

29. A device according to claim 18, wherein the polymerizable phosphorescent organometallic compound comprises an organometallic complex of formula 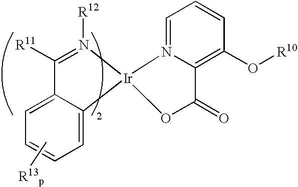
wherein
R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy; styryl, acryloyl, methacryloyl or a combination thereof;
R¹¹ and R¹² taken together form a substituted or unsubstituted monocyclic or bicyclic heteroaromatic ring;
R¹³ is independently at each occurrence halo, nitro, hydroxy, amino, alkyl, aryl, arylalkyl, alkoxy, substituted alkoxy, substituted alkyl, substituted aryl, or substituted arylalkyl; and
p is 0, or an integers ranging from 1 to 4.

30. A device according to claim 18, wherein R¹⁰ is styryl.

31. A device according to claim 18, wherein R¹⁰ is acryloyl or methacryloyl.

32. A device according to claim 18, wherein the polymerizable phosphorescent organometallic compound comprises an organometallic complex of formula 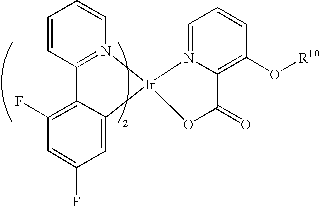
wherein
R¹⁰ is C₂₋₂₀ alkenyl, C₂₋₂₀ alkynyl, C₂₋₂₀ substituted alkenyl, C₂₋₂₀ substituted alkynyl, C₂₋₂₀ alkynyloxy, styryl, acryloyl, methacryloyl or a combination thereof.

33. A device according to claim 18, wherein the emissive layer further comprises structural units derived from (meth)acrylic acid, esters of (meth)acrylic acid, (meth)acrylic amides, vinyl aromatic monomers, substituted ethylene monomers, and combinations thereof.

34. A device according to claim 18, wherein the polymerizable phosphorescent organometallic compound is a compound of formula 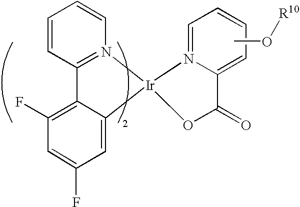
R¹⁰ is styryl, acryloyl, methacryloyl or a combination thereof; and
the polymer comprises structural units derived from a monomer selected from [chemical structure]
